(19) United States
(12) Patent Application Publication
(10) Pub. No.: US 2016/0292173 A1
(43) Pub. Date: Oct. 6, 2016

(54) REMOVABLE STORAGE DATA HASH

(71) Applicant: HEWLETT PACKARD DEVELOPMENT COMPANY, L.P., Houston, TX (US)

(72) Inventor: David H. HANES, Fort Collins, CO (US)

(73) Assignee: HEWLETT PACKARD DEVELOPMENT COMPANY, L.P., Houston, TX (US)

(21) Appl. No.: 15/035,443

(22) PCT Filed: Nov. 20, 2013
(86) PCT No.: PCT/US2013/071023

§ 371 Date: May 9, 2016

(51) Int. Cl. G06F 17/30

(52) U.S. Cl. CPC G06F 17/30097; G06F 17/30109; G06F 17/3033

(57) ABSTRACT

A media server in accordance with an example may include a reader, a hash checker, a database manager, and a server. The reader may read data from a removable storage. The hash checker may calculated a calculated hash value and determine if it is equal to a saved hash value. If the calculated hash value is equal to or does not equal the saved hash value, the database manager may retrieve a saved database or generate a generated database. The server may serve the saved database or the generated database.

### BACKGROUND

A media server may store and provide various digital media, such as video, music, and picture files. A media server may be a dedicated computer appliance or an application running on a personal computer used to share media files to consumer electronic devices. For example, Universal Plug and Play (UPnP) is a set of networking protocols that may be used by a media server to share media files. Digital Living Network Alliance (ULNA) Certified devices use UPnP and must support certain types of media file format, encodings, and resolutions.

### BRIEF DESCRIPTION OF THE DRAWINGS

Certain examples are described in the following detailed description and in reference to the drawings, in which:

FIG. 1 illustrates an example media server having a database manager to retrieve a saved database or generate a generated database;

FIG. 2 illustrates an example process of providing a database to a client; and

FIG. 3 illustrates an example system having a non-transitory computer readable medium storing instructions to implement a media server.

### DETAILED DESCRIPTION OF SPECIFIC EXAMPLES

Some media servers build databases reflecting servable content, such as videos, audio files, and images, which may be provided to clients. For example, a media server's database may contain metadata associated with library of media content that may be provided to clients. A client may interact with the media server to search or browse the media library to identify desired content.

A media server may build a database by scanning an attached storage volume for deliverable content. In some cases, the database may include various information regarding included media files. For example, a database may include file names, file type, resolution, album name, artist name, length, size, and other metadata. The process of collecting this information and building the database may take a significant amount of time.

In some cases, a media server may accommodate removable storage. For example, the media server may have a Secure Digital (SD) memory card reader, other removable media drive, or port to connect to an external hard drive. Rebuilding the database each time a user attaches a new removable storage volume may create unsatisfactory delays before media can be served to clients. The media server may save a database corresponding to a removable storage volume. However, if a user removes the storage volume and makes changes to it the database may be out of sync when the user reattaches the storage volume.

Implementations of the disclosed technology may allow a media server to detect whether media files on an attached removable storage volume have changed since a saved database was generated. This may allow the media server to determine whether to use a saved database or to generate a new database. This may allow the media server to avoid rebuilding a database each time a removable storage volume is attached, which may eliminate the delay before media can be served to clients.

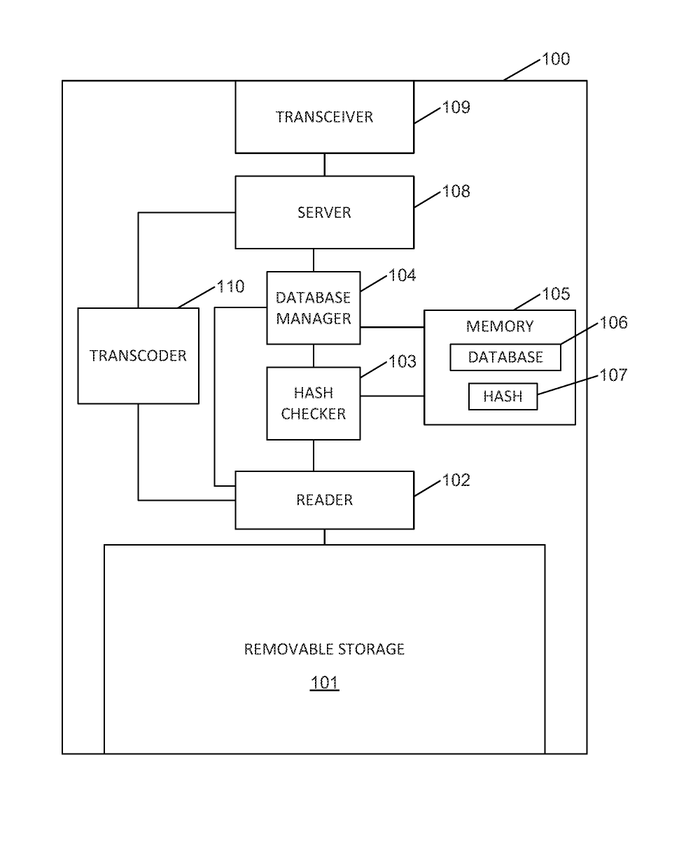

FIG. 1 illustrates an example media server 100 having a database manager 104 to retrieve a saved database or generate a generated database. For example, the media server 100 may be a mobile storage device that can attach to a removable storage device and stream media to clients such as smartphones and tablet computers. In some examples, the illustrated modules may be implemented as processor-executable instructions stored on non-transitory computer readable media, as hardware, or as a combination of the two.

The example server 100 may include a reader 102. The reader 102 may read data from a removable storage 101. For example, the reader 102 may connect to a removable storage 101 using a bus and read data from the removable storage 101 over the bus. In various implementations, various storage devices may be the removable storage 101. For example, the removable storage 101 may be a removable flash memory storage volume, such as an SD card, or an external drive, such as an external hard drive (HD) or external solid state drive (SSD).

The data read by the reader 102 may include a file system structure or file system structures of the removable storage 101. A file system structure may be any data structure that represents or reflects the stored contents of the removable storage 101. For example, a file system structure may be a file allocation table, a file change log, a free space bitmap, a directory, a master file table, file system records and attributes, or file system journals. The file system structure may depend on the format of the removable storage 101. For example, in a File Allocation Table (FAT) formatted storage 101, a file system structure may be the file allocation table or a directory table. In this example, the reader 102 may read the file allocation table or may read a set of directory tables. As another example, in a New Technology File System (NTFS) formatted storage 101, a file system structure may be the master file table or Update Sequence Number (USN) Journal. In some implementations, the server 100 may accommodate various formats of storage 101. In such implementations, the reader 102 may detect the format of the storage 101 and read the file system structure or structures in a manner dependent on the format.

In some implementations, the removable storage 101 may store identification information. For example, an SD card may have a Card Identification (CID) register that stores identification information. The reader 102 may read and provide some or all of such identification information. For example, the reader 102 may read and provide a serial number stored in the CID register of storage 101.

The example server 100 may also include a hash checker 103. In some implementations, the hash checker may calculate a calculated hash value using the data provided by the reader. In various implementations, the hash checker 103 may calculate the calculated hash value using various hash functions. For example, the hash checker 103 may use a checksum function, such as a 32 or 64 bit Cyclic Redundancy Check (CRC) function, a non-cryptographic hash function, such as MurmurHash, or a Jenkins hash function, or a cryptographic hash function, such as a Secure Hash Algorithm (SHA).

The hash checker may also determine if the calculated hash value equals a saved hash value 107. For example, the hash checker 103 may retrieve the saved hash value 107 from a memory 105. For example, the memory 105 may be an internal memory, such as random access memory (RAM), flash memory, or an internal storage volume.

In some implementations, the saved hash value 107 may be associated with an identification of the storage 101. For example, the hash checker 103 may use the identification provided by the reader 102 from the removable storage 101 to identify the saved hash value 107. In some cases, the hash checker 103 may save the calculated hash value as the saved hash value 107 for future use.

In other implementations, the saved hash value 107 may be stored unassociated with storage identification. In these implementations, the hash checker 103 may compare the calculated hash value to a plurality of saved hash values 107 until it finds a match. In these implementations, if the calculated hash value does not equal a saved hash value 107, the hash checker 103 may store the calculated hash value as a saved hash value 107. For example, the hash checker 103 may add the calculated hash value to a saved hash value 107 table stored in the memory 105. As another example, the hash checker 103 may replace an oldest or least-used saved hash value 107 with the calculated hash value.

The example media server 100 may also include a database manager 104. In some implementations, the database manager 104 may be coupled to the hash checker 103 to obtain an indication of whether the calculated hash value equals a saved hash value 107. The database manager 104 may retrieve a saved database 106 if the calculated hash value equals the saved hash value 107. For example, the saved database 106 may be a media database generated when the storage 101 was previously attached to the server 100. If the contents of the storage 101 have not changed since the storage 101 was previously attached, then the calculated hash value will equal the saved hash value 107. Accordingly, the saved database 106 may reflect the current contents of the storage 101 and a new database may not need to be built. This may allow the media server 100 to begin serving the contents of the storage 101 without forcing the user to wait for a media database to be generated.

The database manager 104 may generate a generated database if the calculated hash value does not equal the saved hash value 107. For example, the database manager 104 may use the reader 102 to generate a generated media database of media contents stored on storage 101 that may be served to clients by the media server 100. If the contents of the storage 101 have changed since the storage 101 was previously attached, then the calculated hash value will not equal the saved hash value 107. Accordingly, the database manger 104 may generate a generated database to reflect the changed contents of the storage 101. This may avoid the media server 100 serving a corrupted or out of date database to clients.

In some implementations, the database manager 104 may save the generated database associated with the calculated hash value. If the calculated hash and saved hash 107 are associated with a storage identification, then the saved database 106 may be associated with the same storage identification. If the calculated hash does not equal the saved hash 107, then the database manager 104 may replace the saved database 106 with the generated database. As another example, the memory 105 may store a table of databases 106 indexed by hash values 107. In some cases, the database manager 104 may add an entry to such a table using the calculated hash value and the generated database. In other cases, the database manager 104 may replace an entry in such a table with the calculated hash value and the generated database. For example, the database manager 104 may replace an oldest or least used entry.

The example media server 100 may also include a server 108. The server 108 may serve the saved database or the generated database. The server 108 may obtain the saved database 106 or the generated database from the database manager 104. For example, if the calculated hash value equals the saved hash value 107, the database manager 104 may provide the saved database 106 to the server 108. As another example, if the calculated hash value does not equal the saved hash value 107, the database manager 104 may provide the generated database to the server 108. The server 108 may serve the saved database or the generated database in various manners. For example, the server 108 may transmit a listing of the elements of the database. As another example, the server 108 may provide an interface to allow a client to search the database.

The server 108 may also serve contents of the removable storage 101 to connected clients. For example, a client may use the database to select a media content item stored on the storage 101. The server 108 may serve the selected media content item to the client. For example, the server 108 may stream the selected media content item for playback on the client or for playback on a media player coupled to the client. As another example, the server 108 may transfer a copy of the selected media content item to the client for storage. In some implementations, the example media server 100 may include a transcoder 110. In these implementations, the server 108 may use the transcoder 110 to transcode a media content item stored in a first format into a second format for playback at the client. In some implementations, the server 108 may use a transceiver 109 to serve clients the saved database 107 or the generated data. For example, the transceiver 109 may be a wireless transceiver, such as a Wi-Fi transceiver or a wired transceiver, such as an Ethernet or MoCA (Multimedia over Coax Alliance) transceiver.

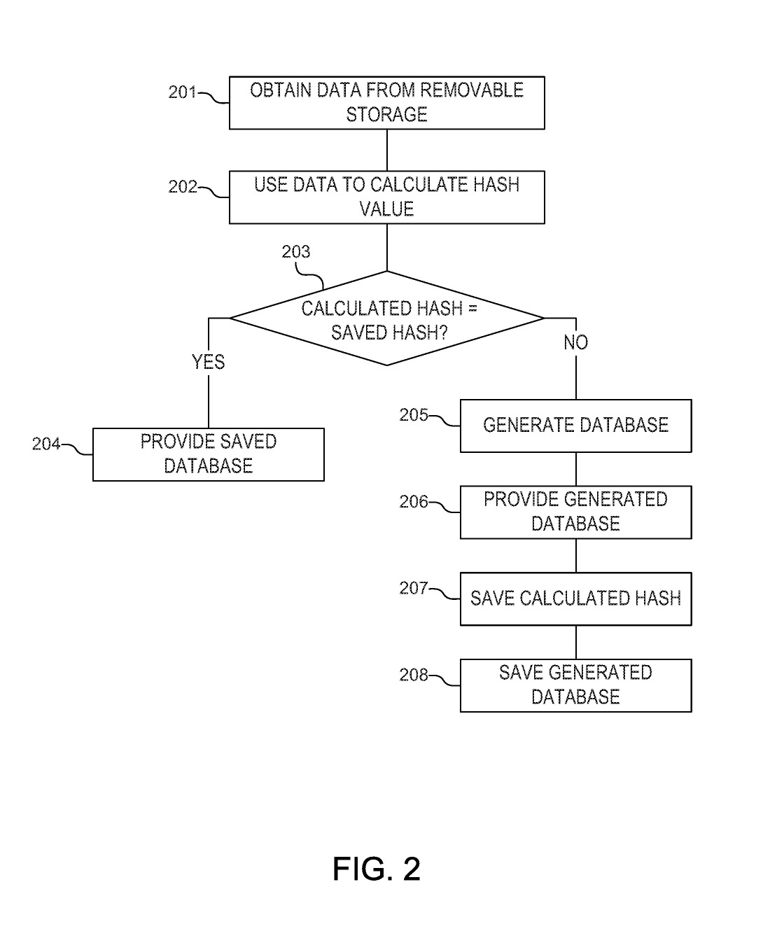

FIG. 2 illustrates an example process of providing a database to a client. For example, the example media server 100 described with respect to FIG. 1 may perform the illustrated example process.

The example process may include block 201. Block 201 may include a media server obtaining data from a removable storage. For example, the removable storage may be a removable drive attached to the media server, such as an SD card or a USB hard drive or SSD. In some implementations, the data may be data other than the actual media files stored on the removable storage but that represents or reflects the media files stored on the removable storage. For example, the data may include a file system structure used by the file system of the removable storage to manage stored files. For example, the data structure may include a file allocation table, a directory table, a set of directory tables, a master file table, or a USN journal. In some implementations, the data may comprise a plurality of file system structures. For example, the data may comprise a set of directory tables, or a file allocation table and free space bitmap.

The example process may also include block 202. Block 202 may include the media server using the data as an argument in a hash function to obtain a calculated hash value. For example, the hash function may be a checksum function, such as a 32 or 64 bit Cyclic Redundancy Check (CRC) function, a non-cryptographic hash function, such as MurmurHash, or a Jenkins hash function, or a cryptographic hash function, such as a Secure Hash Algorithm (SHA).

In some implementations, block 202 may include calculating a hash value for each of a plurality of sets of data. For example, each set of data may be a separate file system data structure, such as a directory. In these implementations, block 202 may include calculating a plurality of calculated hash values, each hash value corresponding to a set of data. As described below, this may allow the media server to determine a subset of files on the removable storage that have changed, and a subset of files on the removable storage that have remained unchanged.

As another example, each set of data may be a portion of file system structure. For example, block 202 may include the media server apportioning the file system structure into a plurality of file system portions. Block 202 may further include a calculated portion hash value for each file system portion. As an example, block 202 may include partitioning a FAT table, such as a FAT32 table, into multiple partitions and calculating a hash value for each partition. Accordingly, each calculated portion hash value may correspond to a particular set of storage addresses on the removable storage.

The example process may also include block 203. Block 203 may include the media server comparing the calculated hash value to a saved hash value. For example, the saved hash value may be a hash value that was calculated when the removable storage was connected to the media server on a previous occasion. In further implementations, the media server may store a plurality of different hash values. For example, each time the media server calculates a distinct hash value, the media server may store it. As another example, the media server may store up to a set number of distinct hash values. In some implementations, the media server may compare the calculated hash to each saved hash value to determine if the calculated hash matches any of the saved hash value. In other implementations, the media server may store the saved hash value associated with a removable storage identifier. In these instances, the media server may read an identifier from the removable storage and use the identifier to retrieve the saved hash value.

In some implementations, block 203 may include comparing a plurality of calculated hash values to a plurality of saved hash values. For example, if block 202 is performed for each of a plurality of sets of data, block 203 may be performed for each of the plurality of calculated hash values. In some cases, each of the calculated hash values may be checked against a plurality of saved hash values. If a calculated hash value equals a saved hash value, then the files corresponding to the calculated hash value may not have changed since the removable storage was previously attached. For examples, the directory used to calculate the equal hash value may be unchanged. If a calculated hash value does not equal any of the saved hash values, then the files corresponding to the calculated hash value may have changed since the removable storage was previously attached. For example, the directory used to calculate the unequal hash value may be changed.

In further implementations, if block 202 includes apportioning a file system structure into a plurality of file system portions, block 203 may include comparing the plurality of calculated portion hash values to corresponding saved portion hash values. For example, the corresponding saved portion hash values may be saved hash values corresponding to previously calculated portion hash values. For example, the corresponding saved portion hash values may be hash values calculated on equal-size partitions of a FAT table, such as a FAT32 table.

The example process may include block 204. In some implementations, block 204 may be performed if the media determines that the calculated hash equals the saved hash in block 203. Block 204 may include the media server providing a saved database to serve media files stored on the removable storage. For example, the media server may retrieve a saved database associated with the saved hash value. In some implementations, the media server may provide the saved database in a manner compliant with UPnP or DLNA protocols. For example, the media server may provide clients a listing of media files in the database or may provide an interface to allow the clients to search the database. In some cases, the saved database was generated when the removable storage was connected to the media server on a previous occasion. For example, the saved database may be generated when the saved hash value was calculated. The saved database may therefore reflect the contents of the removable storage when the saved hash value was created. If the calculated hash value is equal to the saved hash value, this may indicate that the contents of the removable storage have not changed since the saved hash value was calculated. Accordingly, the saved database may be used to accurately reflect the current contents of the removable storage.

In some implementations, the saved database may reflect a portion of the files on the removable storage. For example, this may occur if block 203 includes comparing a plurality of calculated hash values to a plurality of saved hash values, the saved database may correspond to a calculated hash value that equals one of the saved hash values. As another example, this may occur if block 202 includes apportioning a file system structure and determining a calculated portion hash value for each file system portion. In these implementations, block 204 may additionally include providing multiple saved databases. For example, if multiple calculated hash values equal saved hash values of the plurality of saved hash values, a different saved database may be provided for each equal hash value.

In some implementations, block 204 may also include serving media files reflected in the saved database. For example, block 204 may include streaming a media file selected by a client upon reviewing the saved database. In these implementations, block 204 may also include transcoding media files to serve them in a format required by the client. As another example, block 204 may include combining multiple saved databases into a streaming database, and serving the streaming database. In some cases, the saved databases may also be combined with databases generated in step 206, as described below.

The example process may also include block 205. In some implementations, block 205 may be performed if it is determined in block 203 that the calculated hash value does not equal the saved hash value. Block 205 may include the media server generating a generated database. For example, the media server may generate the generated database by scanning the contents of the removable storage to add file names and file information, such as metadata like album art, titles, and format information to the generated database. In some cases, the resultant generated database may include all files that may be served to clients in compliance with a protocol such as UPnP or DLNA.

In some implementations, block 205 may include generating a generated database for each calculated hash value that does not equal any of the plurality of hash values. For example, this may occur if multiple calculated hash values are compared to a plurality of hash values in block 203. As another example, this may occur if block 202 includes apportioning a file system structure and determining a calculated portion hash value for each file system portion. In some cases, block 205 may include determining which directories correspond to the unequal hash values and generating databases for those directories. As another example, block 205 may include determining which files correspond to the portion of the file structure and generating a generated database for those files. For example, if the portion of the file system structure is a partition of a FAT table, block 205 may include scanning files stored in addresses covered by the partition of the FAT table.

The example process may also include block 206. In some implementations, block 206 may be performed if it is determined in block 203 that the calculated hash value does not equal the saved hash value. Block 206 may include providing the generated database generated in block 205. For example, the media server may provide the generated database by providing the database to a connected client. For example, the media server may provide the generated database in a manner compliant with a streaming protocol such as UPnP or DLNA.

In some implementations, block 206 may include providing multiple generated databases. For example, if multiple databases were generated in block 205, then they may be provided in block 206. Additionally, if block 204 is performed for any hash values, the databases generated in block 204 may be provided together with the saved databases. For example, a combined database may be generated that reflects any servable media in a FAT table by combining the databases retrieved in block 204 and generated in block 205.

The example process may also include block 207, which may be performed if the calculated hash value does not equal the saved hash value. Block 207 may include saving the calculated hash value. For example, if a removable storage ID is used, the calculated hash value may be saved in association with the removable storage ID, which may replace the previously saved hash value used in block 203. As another example, the calculated hash value may be saved as an element in a set of saved hash values. For example, the calculated hash value may be added to the set of saved hash values, or may replace a previously existing element of the set of saved hash values. In some implementations, block 207 may further include saving a plurality of calculated values. For example, each calculated hash value that did not equal a saved hash value in block 203 may be saved.

If the example process includes block 207, then the example process may also include block 208. Block 208 may include saving the generated database. The generated database may be saved in association with the calculated hash value that was saved in block 207. In some implementations, the generated database may replace a previously saved database. In other implementations, the generated database may be added to a set of saved databases. In further implementations, block 208 may include saving a plurality of generated databases. For example, each calculated hash value saved in block 207 may have an associated generated database that is saved.

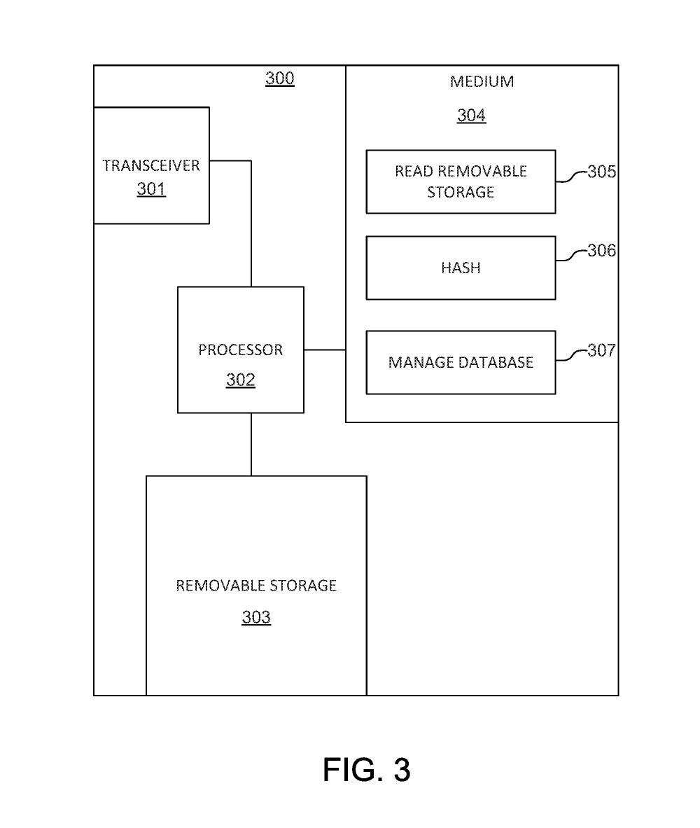

FIG. 3 illustrates an example system 300 having a non-transitory computer readable medium 304 storing instructions to implement a media server. In some cases, the example system may be an implementation of the media server of FIG. 1 and may perform an implementation of the process of FIG. 2.

The example system 300 may include a transceiver 301 and a removable storage 303. In some implementations, the transceiver 301 may be as described with respect to transceiver 109 of FIG. 1. For example, the transceiver 301 may be a wired or wireless transceiver. The removable storage 303 may be as described with respect to removable storage 101 of FIG. 1. For example, the removable storage 303 may be a removable flash memory storage volume, such as an SD card, or an attached external drive, such as an external HD or SSD.

The example system may also include a processor 302. In some implementations, the processor 302 may execute instructions 305, 306, 307 stored on the non-transitory computer readable medium 304 to implement modules such as the reader 102, hash checker 103, database manager 104, transcoder 110, and server 108 of FIG. 1. In other implementations, some of these modules may be executed partially or entirely by hardware modules.

The non-transitory computer readable medium 304 may include instructions 305. In some implementations, the instructions 305 may cause the system 300 to perform block 201 described with respect to FIG. 2 or to implement the reader 102 as described with respect to FIG. 1. Instructions 305 may be executable by the processor 302 to retrieve a file system structure from a removable storage. In further implementations, the instruction 205 may be executable by the processor to retrieve an identification (ID) from the removable storage 303. For example, the processor may retrieve an ID number for an identification register on an SD card.

The non-transitory computer readable medium 304 may further include instructions 306. In some implementations, the instructions 306 may cause the system 300 to perform block 202 of FIG. 2 or to implement the hash checker 103 of FIG. 1. In some cases, the instructions 306 may be executable by the processor 302 to hash the file system structure to calculate a calculated hash value. For example, the processor 302 may execute the instructions 306 to use the file system structure as an argument in a hash function. In a further implementation, the calculated hash value may be one of a plurality of calculated hash values. In this implementation, the instructions 306 may be executable by the processor to hash the file system structure by partitioning the file system structure into a plurality of file system partitions and hashing each of the file system partitions to calculate the plurality of calculated hash values.

The instructions 306 may be executable by the processor 302 to determine whether the calculated hash value equals a saved hash value. For example, the instructions 306 may cause the system 300 to perform block 203 of FIG. 2. If the instructions 306 are executable by the processor 302 to calculate a plurality of calculated hash values, the instructions 306 may be further executable to determine which, if any, of the calculated hash values are equal to any of a plurality of saved hash values. Additionally, if the instructions 306 are executable to cause the processor 302 to retrieve an ID from the removable storage 303, then the instructions 306 may be executable to cause the processor 302 to obtain the saved hash value using the identification.

The non-transitory computer readable medium 304 may further include instructions 307. In some cases, instructions 307 may be executable to cause the system 300 to perform blocks 204-208 of FIG. 2, or to implement the database manager 104 and server 108 of FIG. 1.

In some implementations, the instructions 307 may be executable by the processor 302 to provide a saved database corresponding to the saved hash value. For example, the processor 302 may execute the instructions 307 to provide the saved database if the calculated hash value equals the saved hash value. The instructions 307 may be further executable by the processor 302 to generate a generated database from contents of the removable storage 303, and provide the generated database. For example, the processor 302 may execute the instructions 307 to generate and provide the generated database if the calculated hash value differs from the saved hash value. In further implementations, the instructions 307 may be executable to store the calculated hash value as the saved hash value and store the generated database as the saved database. For example, the processor 302 may execute the instructions 307 to store the calculated hash value and the generated database if the calculated hash value differs from the saved hash value.

If the instructions 306 are executable by the processor 302 to compare a plurality of hash values, then the instructions 307 may be executable by the processor 302 to retrieve saved databases for equal hash values and to generate databases for different hash values. For example, the instructions 307 may be executable by the processor 302 to provide a saved database corresponding to the respective calculated hash value for each respective calculated hash value of the plurality equal to a corresponding saved hash value. Additionally, the instructions 307 may be executable by the processor 302 to generate a corresponding generated database and provide the corresponding generated database for each respective calculated hash value of the plurality not equal to any corresponding saved hash value.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A media server, comprising:
a reader to read data from a removable storage;
a hash checker to calculate a calculated hash value using the data and to determine if the calculated hash value equals a saved hash value; and
a database manager to:
retrieve a saved database if the calculated hash value equals the saved hash value; and
generate a generated database if the calculated hash value does not equal the saved hash value; and
a server to serve the saved database or the generated database.

2. The media server of claim 1, wherein:
the reader is to read an identification from the removable storage; and
the hash checker is to use the identification to identify the saved hash value.

3. The media server of claim 1, wherein:
the hash checker is to save the calculated hash value as the saved hash value if the calculated hash value is not equal to the saved hash value.

4. The media server of claim 1, wherein:
the database manager is to save the generated database associated with the calculated hash value.

5. A method, comprising:
a media server obtaining data from a removable storage;
the media server using the data as an argument in a hash function to obtain a calculated hash value;
the media server comparing the calculated hash value to a saved hash value;
if the calculated hash value equals the saved hash value, the media server providing a saved database to serve media files stored on the removable storage; and
if the calculated hash value does not equal the saved hash value, the media server generating a generated database and providing the generating database.

6. The method of claim 5, wherein the data comprises a file system structure.

7. The method of claim 5, wherein the data comprises a plurality of file systems structures.

8. The method of claim 5, further comprising:
obtaining the saved hash value using an identifier stored on the removable storage.

9. The method of claim 5, further comprising:
the media server obtaining a file system structure;
the media server apportioning the file system structure into a plurality of file system portions, the data being one of the file system portions;
the media server determining a calculated portion hash value for each file system portion, the calculated hash value being one of the calculated portion hash values;
for calculated portion hash values equal to corresponding saved portion hash values, the media server providing saved databases; and
for calculated portion hash values not equal to corresponding saved portion hash values, the media server generating generated databases and providing the generated databases.

10. The method of claim 5, wherein the data comprises a portion of a file system structure, and the method further comprising:
if the calculated hash value does not equal the saved hash value, the media server determining files corresponding to the portion of the file structure and generating the generated database for the files.

11. A non-transitory computer readable medium storing instructions executable by a processor to:
retrieve a file system structure from a removable storage;
hash the file system structure to calculate a calculated hash value;
determine whether the calculated hash value equals a saved hash value;
if the calculated hash value equals the saved hash value, provide a saved database corresponding to the saved hash value; and
if the calculated hash value differs from the saved hash value,
generate a generated database from contents of the removable storage, and
provide the generated database.

12. The non-transitory computer readable medium of claim 11 storing further instructions executable by the processor to:
if the calculated hash value differs from the saved hash value, store the calculated hash value as the saved hash value and store the generated database as the saved database.

13. The non-transitory computer readable medium of claim 11 storing further instructions executable by the processor to:
retrieve an identification from the removable storage; and
obtain the saved hash value using the identification.

14. The non-transitory computer readable medium of claim 11 storing further instructions executable by the processor to:
hash the file system structure by partitioning the file system structure into a plurality of file system partitions and hashing each of the file system partitions to calculate a plurality of calculated hash values, the calculated hash value being one of the plurality.

15. The non-transitory computer readable medium of claim 14 storing further instructions executable by the processor to:
for each respective calculated hash value of the plurality equal to a corresponding saved hash value, provide a saved database corresponding to the respective calculated hash value; and
for each respective calculated hash value of the plurality not equal to any corresponding saved hash value, generate a corresponding generated database and provide the corresponding generated database.
